(19) United States
(12) Patent Application Publication
(10) Pub. No.: US 2018/0291151 A1
(43) Pub. Date: Oct. 11, 2018

(54) Functionalized Polyamides And Methods Of Preparing The Same

(71) Applicant: Firestone Fibers & Textiles Company, LLC, Kings Mountain, NC (US)

(72) Inventors: Laura S. Kocsis, Copley, OH (US); William L. Hergenrother, Akron, OH (US); Terrence E. Hogan, Uniontown, OH (US)

(21) Appl. No.: 15/949,712

(22) Filed: Apr. 10, 2018

Related U.S. Application Data
(60) Provisional application No. 62/483,534, filed on Apr. 10, 2017.

(51) Int. Cl. C08G 69/48; C08G 69/16

(52) U.S. Cl. CPC C08G 69/48; C08G 69/16

(57) ABSTRACT

A functionalized polyamide is prepared by reacting a multifunctional organic compound with an amide monomer in an aqueous liquid at elevated temperature. In the reaction, the multifunctional organic compound is a multifunctional acid compound or a multifunctional amine compound. The amide monomer is preferably a lactam compound. The functionalized polyamide, such as nylon, includes a multifunctional acid or multifunctional amine terminal end that results in increased crystallinity above 30% and an enthalpy of at least 60 J/g.

This application claims the benefit of U.S. provisional application Ser. No. 62/483,534 filed Apr. 10, 2017, the contents of which are incorporated herein in their entirety by reference.

### TECHNICAL FIELD

The present disclosure relates to a functionalized polyamide and methods of preparing the same. The functionalized polyamide includes a multifunctional acid or a multifunctional amine terminal end and has increased levels of crystallinity.

### BACKGROUND

Polyamides are widely used in a number of applications, such as food and beverage containers, tubing, tires, fibers, films, carpets, garments and the like because they have excellent strength, durability, and heat resistance among various materials.

A characteristic of a polyamide that is directly related to many of the desired properties is the amount of crystallinity exhibited in the polyamide. The crystal structure is based on the packing of the polymer chains. Some polymeric materials, once cooled after being heated, form crystals, anywhere from lightly crystallized at 0-10% crystalline (less ordered, amorphous) to as much as 90-95% crystalline (highly ordered). Advantages of increased crystallization include an increase in several properties, such as tensile strength, among others.

The amount of hydrogen bonding between polymer chains plays a role in the compound's crystallinity. Generally, increased hydrogen bonding between adjacent polymer chains leads to increased ordering, which leads to increased crystallinity. Alternatively, when there are fewer hydrogen bonds between polymer chains, the degree of ordering is reduced, which leads to a more amorphous compound with reduced levels of crystallinity.

There is a need to increase the level of crystallinity in polyamide materials in order to provide materials with improved physical properties, such as tensile strength, while maintaining other properties, such as relative viscosity.

It is an objective of the present disclosure to provide methods of improving the crystallinity in polyamides. It has been found that polyamides with multifunctional acid or multifunctional amine terminal ends provide increased crystallinity, which may lead to improved tensile properties.

### SUMMARY

In a first aspect, disclosed is a process of preparing a functionalized polyamide. The process includes reacting a multifunctional organic compound with an amide monomer.

In an example of aspect 1, the multifunctional organic compound is a multifunctional acid compound or a multifunctional amine compound.

In another example of aspect 1, the multifunctional organic compound is a multifunctional acid compound with at least two carboxylic acid groups.

In another example of aspect 1, the multifunctional organic compound is a multifunctional acid compound that is a dicarboxylic acid or a tricarboxylic acid.

In another example of aspect 1, the multifunctional organic compound is a multifunctional amine compound that includes at least two primary amino groups.

In another example of aspect 1, the amide monomer is ε-caprolactam.

In another example of aspect 1, the multifunctional organic compound is reacted with the amide monomer at a temperature of 150° C. to 300° C.

In another example of aspect 1, the multifunctional organic compound is phthalic acid or 1,2,3-benzenetricarboxylic acid and the amide monomer is ε-caprolactam.

In another example of aspect 1, the multifunctional organic compound is diethylenetriamine, triethylenetetramine, or tris(2-aminoethyl)amine and the amide monomer is ε-caprolactam.

In another example of aspect 1, 0.01 to 2 weight percent of the multifunctional organic compound, based upon the weight of the amide monomer, is used to prepare the functionalized polyamide.

In a second aspect, there is functionalized polyamide that includes a multifunctional terminal end prepared by a process that includes reacting a multifunctional organic compound with an amide monomer.

In an example of aspect 2, the multifunctional organic compound is a multifunctional acid compound or a multifunctional amine compound.

In another example of aspect 2, the multifunctional organic compound is a multifunctional acid compound with at least two carboxylic acid groups.

In another example of aspect 2, the multifunctional organic compound is a multifunctional acid compound that is a dicarboxylic acid or a tricarboxylic acid.

In another example of aspect 2, the multifunctional organic compound is a multifunctional amine compound that includes at least two primary amino groups.

In another example of aspect 2, the amide monomer is ε-caprolactam.

In another example of aspect 2, the multifunctional organic compound is phthalic acid or 1,2,3-benzenetricarboxylic acid and the amide monomer is ε-caprolactam.

In another example of aspect 2, the multifunctional organic compound is diethylenetriamine, triethylenetetramine, or tris(2-aminoethyl)amine and the amide monomer is ε-caprolactam.

In another example of aspect 2, the multifunctional organic compound is reacted with the amide monomer at a temperature of 150° C. to 300° C.

In another example of aspect 2, the functionalized polyamide is a sulfur-functionalized nylon-6.

In another example of aspect 2, the crystallinity of the functionalized polyamide is at least 30%.

In another example of aspect 2, the enthalpy (ΔH_{f}) of the functionalized polyamide is at least 60 J/g.

In another example of aspect 2, 0.01 to 2 weight percent of the multifunctional organic compound, based upon the weight of the amide monomer, is used to prepare the functionalized polyamide.

In a third aspect, there is a functionalized polyamide that includes a multifunctional terminal end. The functionalized polyamide is prepared by reacting a multifunctional organic compound with ε-caprolactam. The multifunctional organic compound is selected from a dicarboxylic acid, a tricarboxylic acid, phtalic acid, 1,2,3-benzenetricarboxylic acid, dietyhylenetriamine, triethylenetramine, or tris(2-aminoetheyl)amine. The crystallinity of the functionalized polyamide is at least 30% and the enthalpy (ΔH_{f}) of the functionalized polyamide is at least 60 J/g.

Any one of the above aspects (or examples of those aspects) may be provided alone or in combination with any one or more of the examples of that aspect discussed above; e.g., the first aspect may be provided alone or in combination with any one or more of the examples of the first aspect discussed above; and the second aspect may be provided alone or in combination with any one or more of the examples of the second aspect discussed above; and so-forth.

### DETAILED DESCRIPTION

The terminology as set forth herein is for description of the embodiments only and should not be construed as limiting the invention as a whole.

Herein, when a range such as 5-25 (or 5 to 25) is given, this means preferably at least or more than 5 and, separately and independently, preferably not more than 25. In an example, such a range defines independently at least 5, and separately and independently, not more than 25.

The present disclosure relates to functionalized polyamides prepared by reacting a multifunctional organic compound with an amide monomer. In one or more embodiments, the functionalized polyamides have increased levels of crystallinity. In other embodiments, the functionalized polyamides have increased enthalpy (ΔH_{f}) values.

In one or more embodiments, the functionalized polyamide is a functionalized nylon. Nylon is the generic name for a family of polyamide polymers characterized by the presence of an amine (—NH) group and an acid (—C═O) group within the monomer. Nylons can include nylon-6 (polycaproamide), nylon-7, nylon-8, nylon-9, nylon-10, nylon-11 (polyundecanoamide), and nylon-12.

In one or more embodiments, the multifunctional organic compound is a multifunctional acid compound. In one embodiment, the multifunctional acid compound is a dicarboxylic acid, tricarboxylic acid, or tetracarboxylic acid. In other embodiments, the multifunctional acid compound has more than two carboxylic acid groups. Non-limiting examples of multifunctional acid compounds include aliphatic acids with more than one carboxylic acid moiety, for example, tetrahydrophthalic acid, hexahydrophthalic acid, oxalic acid, adipic acid, azelaic acid, sebacic acid, succinic acid, malic acid, glutaric acid, malonic acid, pimelic acid, suberic acid, 2,2-dimethylsuccinic acid, 3,3-dimethylglutaric acid, 2,2-dimethylglutaric acid, maleic acid, fumaric acid, 1,1,2-dodecanetricarboxylic acid, citric acid, aconitic acid, tetrahydrofurantetracarboxylic acid, tricarballylic acid, and itaconic acid; and aromatic acids with more than one carboxylic acid moiety, for example, phthalic acid, isophthalic acid, terephthalic acid, 1,2,3-benzenetricarboyxlic acid, 1,2,4-benzenetricarboxylic acid, 1,2,4,5-benzenetetracarboxylic acid, trimellitic acid, and tetrachlorophthalic acid. One of these or two or more thereof may be used.

In one or more embodiments, the multifunctional organic compound is a multifunctional amine compound. In one embodiment, the multifunctional amine compound includes at least two primary amino groups. Non-limiting examples of multifunctional amine compounds include aliphatic amines, for example, triethylenetetramine, tetraethylenepentamine, pentaethylenehexamine, diethylenetriamine, tris(2-aminoethyl)amine, 1,6-hexanediamine, 3,3,5-trimethyl-1,6-hexanediamine, 3,5,5-trimethyl-1,6-hexanediamine, 2-methyl-1,5-pentanediamine, bis-(3-aminopropyl)amine, N,N′-bis-(3-aminopropyl)-1,2-ethanediamine, methylenediamine, 1,2-ethylenediamine, 1,3-propanediamine, 1,4-butanediamine, 1,5-pentanediamine, 1,6-hexanediamine, 1,7-heptanediamine, 1,8-octanediamine, 1,9-nonanediamine, 1,10-decanediamine, 1,2-propanediamine, 1,2-butanediamine, 1,2-cyclohexyldiamino, and aminoethylpiperazine; poly(alkylene oxide)diamines and triamines commercially available under the Jeffamine name from Huntsman Corporation, for example, Jeffamine™ D-230, Jeffamine™ D-400, Jeffamine™ D-2000, Jeffamine™ D-4000, Jeffamine™ T-403, Jeffamine™ EDR-148, Jeffamine™ EDR-192, Jeffamine™ C-346, Jeffamine™ ED-600, Jeffamine™ ED-900, and Jeffamine™ ED-2001; primary diamines having an aromatic ring(s), for example, m-phenylenediamine, p-phenylene-diamine, benzidine, methylenebisdianiline, 4,4′-diaminobiphenylether, dianisidine, 3,3′,4-triaminobiphenylether, 3,3′,4,4′-tetraaminobiphenylether, 3,3′-dioxybenzidine, 1,8-naphthalenediamine, m(p)-monomethylphenylenediamine, 3,3′-monomethylamino-4,4′-diaminobiphenylether, 4,N,N′-(4-aminobenzoyl)-p(m)-phenylenediamine-2,2′-bis(4-aminophenylbenzo-imidazole), 2,2′-bis(4-aminophenylbenzooxazole), and 2,2′-bis(4-aminophenylbenzothiazole); secondary diamines, for example, piperazine and piperidine; cycloaliphatic and aromatic amines, for example, 1,2-diaminocyclohexane, 1,3-diaminocyclohexane, 1,4-diaminocyclohexane, hydrogenated ortho-toluenediamine, hydrogenated meta-toluenediamine, metaxylylene diamine, hydrogenated metaxylylene diamine, isophorone diamine, various isomers of norbornane diamine, 3,3′-dimethyl-4,4′-diaminodicyclohexyl methane, 4,4′-diaminodicyclohexyl methane, and 2,4′-diaminodicyclohexyl methane. One of these or two or more thereof may be used.

In one or more embodiments, the functionalized polyamide is prepared by reacting the multifunctional organic compound with an amide monomer. In one embodiment, the amide monomer is a lactam. Non-limiting examples of lactams include ε-caprolactam, enatholactam, undecanolactam, dodecanolactam, α-pyrrolidone, and α-piperidone. One of these or two or more thereof may be used.

In one or more embodiments, 0.01 to 2 weight percent of the multifunctional organic compound, based upon the weight of the amide monomer, is used to prepare the functionalized polyamide. In other embodiments, the amount of the multifunctional organic compound used to prepare the functionalized polyamide is 0.1 to 1.9, 0.2 to 1.8, 0.3 to 1.7, 0.4 to 1.6, or 0.5 to 1.5 weight percent, based upon the weight of the amide monomer.

In one or more embodiments, the reaction of the multifunctional organic compound with the amide monomer is carried out at a temperature which is within the range of 150° C. to 300° C. In other embodiments, the reaction is carried out at a temperature of 160° C. to 290° C., 170° C. to 280° C., 180° C. to 270° C., or 190° C. to 260° C. In other embodiments, the reaction is carried out at a temperature which is at least as high as the melting point of the amide monomer.

In one or more embodiments, the functionalized polyamide has a relative viscosity of at least 1.5 at 25° C. in 1% by weight sulfuric acid solution. In other embodiments, the functionalized polyamide has a relative viscosity of at least 1.6, 1.7, 1.8, 1.9, 2.0, 2.1, 2.2, 2.3, 2.4, or 2.5 at 25° C. in 1% by weight sulfuric acid solution. In other embodiments, the functionalized polyamide has a relative viscosity in the range of 1.5 to 5.0 at 25° C. in 1% by weight sulfuric acid solution. In other embodiments, the functionalized polyamide has a relative viscosity in the range of 1.6 to 4.9, 1.7 to 4.8, 1.8 to 4.7, 1.9 to 4.6, or 2.0 to 4.5 at 25° C. in 1% by weight sulfuric acid solution.

In one or more embodiments, the functionalized polyamide is at least 30% crystalline. In other embodiments, the functionalized polyamide is at least 31%, 32%, 33%, 34%, 35%, 36%, 37%, 38%, 39%, or 40% crystalline. In other embodiments, the crystallinity of the functionalized polyamide is in the range of 25 to 45%. In other embodiments, the crystallinity of the functionalized polyamide is in the range of 28 to 43%, 30 to 41%, 32 to 39%, or 34 to 37%.

In one or more embodiments, the functionalized polyamide has an enthalpy (ΔH_{f}) of at least 60 J/g. In other embodiments, the functionalized polyamide has an enthalpy (ΔH_{f}) of least 62, 64, 66, 68, 70, or 72 J/g. In other embodiments, the functionalized polyamide has an enthalpy (ΔH_{f}) in the range of 45 to 80 J/g. In other embodiments, the functionalized polyamide has an enthalpy (ΔH_{f}) in the range of 47 to 78 J/g, 49 to 76 J/g, 52 to 73 J/g, 54 to 71 J/g, 56 to 69 J/g, 58 to 67 J/g, 60 to 65 J/g, or 62 to 63 J/g.

### EXAMPLES

The following examples illustrate specific and exemplary embodiments and/or features of the embodiments of the present disclosure. The examples are provided solely for the purposes of illustration and should not be construed as limitations of the present disclosure. Numerous variations over these specific examples are possible without departing from the spirit and scope of the presently disclosed embodiments. More specifically, the particular multifunctional organic compounds, amide monomers, and other ingredients utilized in the examples should not be interpreted as limiting since other such ingredients consistent with the disclosure in the Detailed Description can be utilized in substitution. That is, the particular ingredients in the compositions, as well as their respective amounts and relative amounts should be understood to apply to the more general content of the Detailed Description.

The relative viscosity was determined at 25° C. using size 200 viscometers by measuring a 1% solution of the polyamide in concentrated sulfuric acid.

The enthalpy (ΔH_{f}) and change in melting temperature (ΔTₘ) were determined using differential scanning calorimetry (DSC) with a heat-cool-heat cycle from −120° C. to 350° C.

The percent crystallinity was determined with the following equation: percent crystallinity=ΔH_{f}/ΔH₀×100, where ΔH₀=190 J/g as referenced in Baillie, C. A., J. Material Sci., 1999, 34, 5099-5111, which is incorporated herein by reference.

### Comparative Example 1

Molten ε-caprolactam (300 g) was charged into a glass vessel. The vessel was sealed and purged with nitrogen. n-Butylamine (0.74 mL), acetic acid (0.43 mL), and water (3.00 mL) were then charged into the vessel. The vessel was then placed in a nitrogen-purged oven and heated to 260° C. for 18 hours. The hot polymerization mixture was then poured into stirred ice water (1 gallon). The polymerization mixture was then removed from the water and dried under vacuum at 50° C. for 3 hours. The polyamide had the following properties: relative viscosity=1.73, ΔH_{f}=53.4 J/g, crystallinity=28.1%, melting temperature (onset)=207.2° C., melting temperature (peak)=218.3° C., ΔTₘ=11.1° C.

### Example 2

Molten ε-caprolactam (50.0 g) was charged into a glass vessel. The vessel was sealed and purged with nitrogen. n-Butylamine (0.12 mL), phthalic acid (0.104 g), and water (0.50 mL) were then charged into the vessel. The vessel was then placed in a nitrogen-purged oven and heated to 260° C. for 18 hours. The molten polymerization mixture was then poured into stirred ice water (1 gallon). The polymerization mixture was then removed from the water and dried under vacuum at 50° C. for 3 hours. The polyamide had the following properties: relative viscosity=1.80, ΔH_{f}=60.9 J/g, crystallinity=32.1%, melting temperature (onset)=205.2° C., melting temperature (peak)=216.8° C., ΔTₘ=11.6° C.

Use of phthalic acid, an aromatic dicarboxylic acid, to prepare the functionalized polyamide of Example 2 resulted in a 4% increase in the relative viscosity, a 14% increase in the crystallinity, and a 14% increase in the ΔH_{f}, as compared to the polyamide of Comparative Example 1.

### Example 3

Molten ε-caprolactam (50.0 g) was charged into a glass vessel. The vessel was sealed and purged with nitrogen. n-Butylamine (0.12 mL), 1,2,3-benzenetricarboxylic acid (0.088 g), and water (0.50 mL) were then charged into the vessel. The vessel was then placed in a nitrogen-purged oven and heated to 260° C. for 18 hours. The molten polymerization mixture was then poured into stirred ice water (1 gallon). The polymerization mixture was then removed from the water and dried under vacuum at 50° C. for 3 hours. The polyamide had the following properties: relative viscosity=1.79, ΔH_{f}=70.4 J/g, crystallinity=37.1%, melting temperature (onset)=208.1° C., melting temperature (peak)=218.1° C., ΔTₘ=10.0° C.

Use of 1,2,3-benzenetricarboxylic acid, an aromatic tricarboxylic acid, to prepare the functionalized polyamide of Example 3 resulted in a 3% increase in the relative viscosity, a 32% increase in the crystallinity, and a 32% increase in the ΔH_{f}, as compared to the polyamide of Comparative Example 1. The difference in the melting range of the functionalized polyamide of Example 3 was 10% more narrow than the melting range of the polyamide of Comparative Example 1.

### Example 4

Molten ε-caprolactam (49.8 g) was charged into a glass vessel. The vessel was sealed and purged with nitrogen. Diethylenetriamine (0.14 mL), acetic acid (0.21 mL), and water (0.50 mL) were then charged into the vessel. The vessel was then placed in a nitrogen-purged oven and heated to 260° C. for 18 hours. The molten polymerization mixture was then poured into stirred ice water (1 gallon). The polymerization mixture was then removed from the water and dried under vacuum at 50° C. for 3 hours. The polyamide had the following properties: relative viscosity=1.68, ΔH_{f}=64.8 J/g, crystallinity=34.1%, melting temperature (onset)=205.9° C., melting temperature (peak)=217.3° C., ΔTₘ=11.4° C.

Use of diethylenetriamine, an aliphatic secondary amine with two primary amino groups, to prepare the functionalized polyamide of Example 4 resulted in a 3% decrease in the relative viscosity, a 21% increase in the crystallinity, and a 21% increase in the ΔH_{f}, as compared to the polyamide of Comparative Example 1.

### Example 5

Molten ε-caprolactam (50.8 g) was charged into a glass vessel. The vessel was sealed and purged with nitrogen. Triethylenetetramine (0.19 mL), acetic acid (0.29 mL), and water (0.50 mL) were then charged into the vessel. The vessel was then placed in a nitrogen-purged oven and heated to 260° C. for 18 hours. The molten polymerization mixture was then poured into stirred ice water (1 gallon). The polymerization mixture was then removed from the water and dried under vacuum at 50° C. for 3 hours. The polyamide had the following properties: relative viscosity=1.63, ΔH_{f}=67.3 J/g, crystallinity=35.4%, melting temperature (onset)=206.9° C., melting temperature (peak)=218.1° C., and ΔTₘ=11.2° C.

Use of triethylenetetramine, an aliphatic secondary diamine with two primary amino groups, to prepare the functionalized polyamide of Example 5 resulted in a 6% decrease in the relative viscosity, a 26% increase in the crystallinity, and a 26% increase in the ΔH_{f}, as compared to the polyamide of Comparative Example 1.

### Example 6

Molten ε-caprolactam (300.2 g) was charged into a glass vessel. The vessel was sealed and purged with nitrogen. Diethylenetriamine (0.27 mL), acetic acid (0.43 mL), and water (3.00 mL) were then charged into the vessel. The vessel was then placed in a nitrogen-purged oven and heated to 260° C. for 18 hours. The molten polymerization mixture was then poured into stirred ice water (1 gallon). The polymerization mixture was then removed from the water and dried under vacuum at 50° C. for 3 hours. The polyamide had the following properties: relative viscosity=1.77, ΔH_{f}=52.7 J/g, crystallinity=27.7%, melting temperature (onset)=208.0° C., melting temperature (peak)=219.0° C., and ΔTₘ=11.0° C.

Use of diethylenetriamine, an aliphatic secondary amine with two primary amino groups, to prepare the functionalized polyamide of Example 6 resulted in a 2% increase in the relative viscosity, a 1% decrease in the crystallinity, and a 1% decrease in the ΔH_{f}, as compared to the polyamide of Comparative Example 1.

### Example 7

Molten ε-caprolactam (149.9 g) was charged into a glass vessel. The vessel was sealed and purged with nitrogen. Tris(2-aminoethyl)amine (0.19 mL), acetic acid (0.21 mL), and water (1.50 mL) were then charged into the vessel. The vessel was then placed in a nitrogen-purged oven and heated to 260° C. for 18 hours. The molten polymerization mixture was then poured into stirred ice water (1 gallon). The polymerization mixture was then removed from the water and dried under vacuum at 50° C. for 3 hours. The polyamide had the following properties: relative viscosity=1.71, ΔH_{f}=58.2 J/g, crystallinity=30.6%, melting temperature (onset)=207.1° C., melting temperature (peak)=217.7° C., and ΔTₘ=10.6° C.

Use of tris(2-aminoethyl)amine, an aliphatic tertiary amine with three primary amino groups, to prepare the functionalized polyamide of Example 7 resulted in a 1% decrease in the relative viscosity, a 9% increase in the crystallinity, and a 9% increase in the ΔH_{f}, as compared to the polyamide of Comparative Example 1.

The properties of the polyamides of Comparative Example 1 and Examples 2 through 7 are shown in Table 1.

TABLE 1

| Example | 1 (Comparative) | 2 | 3 | 4 | 5 | 6 | 7 |
|---|---|---|---|---|---|---|---|
| Relative Viscosity | 1.73 | 1.80 | 1.79 | 1.68 | 1.63 | 1.77 | 1.71 |
| ΔH_{f} (J/g) | 53.4 | 60.9 | 70.4 | 64.8 | 67.3 | 52.7 | 58.2 |
| Crystallinity (%) | 28.1 | 32.1 | 37.1 | 34.1 | 35.4 | 27.7 | 30.6 |
| Tₘ onset (° C.) | 207.2 | 205.2 | 208.1 | 205.9 | 206.9 | 208.0 | 207.1 |
| Tₘ peak (° C.) | 218.3 | 216.8 | 218.1 | 217.3 | 218.1 | 219.0 | 217.7 |
| ΔTₘ | 11.1 | 11.6 | 10.0 | 11.4 | 11.2 | 11.0 | 10.6 |

All references, including but not limited to patents, patent applications, and non-patent literature are hereby incorporated by reference herein in their entirety.

While various aspects and embodiments of the compositions and methods have been disclosed herein, other aspects and embodiments will be apparent to those skilled in the art. The various aspects and embodiments disclosed herein are for purposes of illustration and are not intended to be limiting, with the true scope and spirit being indicated by the claims.

What is claimed is:

1. A process of preparing a functionalized polyamide comprising reacting a multifunctional organic compound with an amide monomer.

2. The process of claim 1, wherein the multifunctional organic compound is a multifunctional acid compound or a multifunctional amine compound.

3. The process of claim 2, wherein the multifunctional acid compound is a dicarboxylic acid or a tricarboxylic acid.

4. The process of claim 2, wherein the multifunctional amine compound includes at least two primary amino groups.

5. The process of claim 1, wherein the amide monomer is ε-caprolactam.

6. The process of claim 1, wherein the multifunctional organic compound is reacted with the amide monomer at a temperature of 150° C. to 300° C.

7. The process of claim 1, wherein the multifunctional organic compound is selected from the group consisting of phthalic acid, 1,2,3-benzenetricarboxylic acid, diethylenetriamine, triethylenetetramine, and tris(2-aminoethyl)amine and the amide monomer is a lactam selected from the group consisting of ε-caprolactam, enatholactam, undecanolactam, dodecanolactam, α-pyrrolidone, and α-piperidone.

8. The process of claim 1, wherein 0.01 to 2 weight percent of the multifunctional organic compound, based upon the weight of the amide monomer, is used to prepare the functionalized polyamide

9. A functionalized polyamide comprising a multifunctional terminal end prepared by a process comprising reacting a multifunctional organic compound with an amide monomer.

10. The functionalized polyamide of claim 9, wherein the multifunctional organic compound is a multifunctional acid compound or a multifunctional amine compound.

11. The functionalized polyamide of claim 10, wherein the multifunctional acid compound is a dicarboxylic acid or a tricarboxylic acid.

12. The functionalized polyamide of claim 10, wherein the multifunctional amine compound includes at least two primary amino groups.

13. The functionalized polyamide of claim 9, wherein the amide monomer is ε-caprolactam.

14. The functionalized polyamide of claim 9, wherein the multifunctional organic compound is selected from the group consisting of phthalic acid, 1,2,3-benzenetricarboxylic acid, diethylenetriamine, triethylenetetramine, and tris(2-aminoethyl)amine and the amide monomer is a lactam selected from the group consisting of ε-caprolactam, enatholactam, undecanolactam, dodecanolactam, α-pyrrolidone, and α-piperidone.

15. The functionalized polyamide of claim 9, wherein the multifunctional organic compound is reacted with the amide monomer at a temperature of 150° C. to 300° C.

16. The functionalized polyamide of claim 9, wherein the functionalized polyamide is a functionalized nylon-6.

17. The functionalized polyamide of claim 9, wherein the crystallinity of the functionalized polyamide is at least 30%.

18. The functionalized polyamide of claim 9, wherein the enthalpy (ΔH_{f}) of the functionalized polyamide is at least 60 J/g.

19. The functionalized polyamide of claim 9, wherein 0.01 to 2 weight percent of the multifunctional organic compound, based upon the weight of the amide monomer, is used to prepare the functionalized polyamide

20. A functionalized polyamide comprising a multifunctional terminal end prepared by the process comprising: reacting a multifunctional organic compound with ε-caprolactam, the multifunctional organic compound being selected from the group consisting of a dicarboxylic acid, a tricarboxylic acid, phthalic acid, 1,2,3-benzenetricarboxylic acid, dietyhylenetriamine, triethylenetramine, or tris(2-aminoetheyl)amine, and the crystallinity of the functionalized polyamide is at least 30% and the enthalpy (ΔH_{f}) of the functionalized polyamide is at least 60 J/g.
